(19) United States
(12) Patent Application Publication
(10) Pub. No.: US 2008/0129865 A1
(43) Pub. Date: Jun. 5, 2008

(54) System and Methods for Rapid Subtitling

(76) Inventor: Sean Joseph Leonard, San Diego, CA (US)

Correspondence Address: SACHNOFF & WEAVER, LTD., 10 SOUTH WACKER DRIVE, CHICAGO, IL, 60606-7507, US

(21) Appl. No.: 11/935,402

(22) Filed: Nov. 5, 2007

Related U.S. Application Data
(60) Provisional application No. 60/864,411, filed on Nov. 5, 2006.
(60) Provisional application No. 60/865,844, filed on Nov. 14, 2006.

(51) Int. Cl. H04N 7/00

(52) U.S. Cl. 348/468; 348/E07.001

(57) ABSTRACT

A system and method for rapid subtitling and for alignment of various types of data sequences is provided. In one embodiment, the system includes an input module adapted to receive parameter values from a user, a computer readable memory adapted to store the parameters in a manner so that the stored parameters relate at least one event to at least one data sequence, and an analysis module adapted to extract at least one feature from the data sequence and to adjust the parameters based on the at least one feature extracted from the data sequence. In an alternate embodiment, the system treats user-supplied times as a priori data and adjusts those times using extracted features from concurrent and previously-analyzed data streams.

### CROSS REFERENCE TO RELATED APPLICATIONS

This application is based on and claims the benefit of U.S. Provisional Patent Application No. 60/864,411 filed on Nov. 5, 2006 and entitled “A System and Method of Rapid Subtitling,” and U.S. Provisional Patent Application No. 60/865,844 filed on Nov. 14, 2006 and entitled “A System and Method of Rapid Subtitling,” both of which is incorporated herein by reference in their entirety.

### FIELD

This application generally relates to a computer implemented multi-media data processing system, and more specifically, to a system and method for creating, modifying, aligning, and presenting events such as subtitles and other sequences of data with further sequences of data.

### BACKGROUND

There is a need for the embodiments of the present system described herein because previous subtitling systems do not adequately address labor inefficiencies during the timing process. Prior related commercial subtitling systems have small and exclusive user bases, primarily consisting of large broadcasting houses. Their cost and complexity are beyond the reach of fans, academics, and freelance translators. Some in the broadcast industry contend that such commercial systems are less stable than related open-source and freeware counterparts.

Furthermore, no known systems fully implement “i18n” (internationalization) features such as Unicode, language selection, collaborative translation, multilingual font selection, or scrolling text. The plethora of subtitling software has led to hundreds of different file formats for subtitle text.

As best seen in FIG. 1, a prior related subtitling software system 10 is based on workflows for hardware character generator-locking devices (genlocks). Commercial systems have their roots based on these same workflows and genlock devices. However, the technologies for these workflows and genlock devices were eclipsed nearly half a decade ago by all-digital workflows. It is estimated that subtitling a 25-minute video sequence can require as much as four hours with such tools.

As best seen in FIG. 1, a prior related linear timeline layout 12 is straightforward in its implementation, but suffers from several drawbacks. First, the preview/grid size area serves as both the preview window for subtitles and the audio waveform, so it is not possible to see all of a subtitle while editing. Keyboard shortcuts are awkward or nonfunctional, and the waveform preview acts inconsistently: sometimes a click will update the time, other times it will not. Finally, subtitles are arranged in single-file order down the table, and there is no attempt to organize or filter subtitles by author, character, or style, and there is no option to view multiple subtitle sections at once. While other prior related systems, such as second prior related system 20 shown in FIGS. 2-3, disclose feature sets that vary by layouts, multilingual support and video preview windows, these systems also have the same or similar drawbacks. For instance, whether working under audio tab 22 (FIG. 2) or video tab 24 (FIG. 3), second prior related system 20 does not permit real time rendering or viewing.

Combining a transcript and an audiovisual sequence into a subtitled work raises several distinct problem domains: speech boundary detection, phonetic audio alignment, video scene boundary recognition, and character (actor or narrator) recognition.

A sizeable corpus of research has been conducted on speech recognition and synthesis. Phonetic alignment falls under this broad category, and multiple systems exist to address such phonetic alignment. Recent other works suggest that a subtitling system is possible to implement for cases when the repertoire of the recognition system is limited.

Japanese language has many notable complications in this domain. Most systems for phonetic alignment have been tested against limited English corpora, rather than the nearly limitless corpora of Japanese or other languages in fiction films. While there may be fewer syllables in Japanese than English (Japanese has fewer mora, or syllable-units, than English), Japanese tends to be spoken faster than English. Furthermore, the phonetic alignment routine will likely treat a complex and noisy waveform in real-world media clips. In literature on the topic, researchers almost always provide a single, unobstructed speaker as input data to their systems. Using an audio stream that includes music, sound effects, and other speakers presents significant algorithmic challenges.

Likewise, Japanese animation tends to cast a great variety of characters with a few voice-types. Small variations between speakers may confuse the alignment routine, and may prevent detection of speaker change when two similar voices are talking serially or concurrently. Transcripts and translations in the subtitling sphere come pre-labeled with character names, but this serves only as a partial solution. Since characters are known a priori, one might consider operating speech signature detection in cooperative: given known, well-timed subtitles, a classification algorithm can extract audio data from these known samples, and determine which areas of the unknown region correspond to the given character, to another character, or to no character at all.

### SUMMARY

Various embodiments of a system and method for rapid subtitling and alignment of data sequences are described herein. Embodiments of the system disclosed herein result in significant time-savings for users who subtitle or align text on-screen. An embodiment of such a rapid subtitling system reduces the subtitling time spent by users as compared to other subtitling systems.

Among other things, one embodiment of the system disclosed herein addresses three problem domains to achieve overall time-savings: timing, user interface, and format conversion. Specifically, the embodiment implements a novel framework for timing events (including subtitles), or specifying when a subtitle appears and disappears on-screen (or activates and deactivates for other types of data) for later playback.

As well, another embodiment of the subtitling system includes an on-the-fly timing system and a packaged algorithm subsystem, using parameters derived from the subtitle, audio, and video streams, in combination with user input, to rapidly produce and assign accurate subtitle times. Using embodiments of the subtitling system, users such as subtitlers can typeset their work to enhance the readability and visual appearance of text on-screen. Moreover, users may also prepare and process subtitles in many formats using the modular serialization framework of the subtitling system.

### DRAWINGS

While the accompanying claims set forth features of a system and method of embodiments for rapid subtitling and alignment of various types of data sequences that are disclosed herein with particularity, embodiments of the system and method may be best understood from the following detailed description taken in conjunction with the accompanying drawings, of which:

FIG. 1 (Related Art) illustrates a first known subtitling system having a linear timeline view.

FIG. 2 (Related Art) illustrates a second known subtitling system, which differs in implementation details from the first known subtitling system.

FIG. 3 (Related Art) illustrates an alternate view of the second known subtitling system.

FIG. 4 illustrates a high level overview of an embodiment of the subtitling system.

FIG. 5 illustrates an embodiment of the subtitling system, with objects, data flows, and observation cycles as described therein.

FIG. 6 illustrates an embodiment of the subtitling system, including an on-the-fly timing subsystem and a packaged algorithm subsystem.

FIG. 7 illustrates a computer program listing of an embodiment of a packaged algorithm subsystem's preprocessor, presenter, and adjuster interfaces.

FIGS. 8A-8H illustrate timelines with events (subtitles) corresponding to characters or notes, illustrating typical transitions between events (subtitles) in an embodiment of the system.

FIGS. 9A-9B illustrate a computer program listing of an embodiment of a signal-timing function's core start, end, and adjacent signal handling.

FIG. 10 illustrates an embodiment of a pipeline storage 2D array and control flow through the pipeline stages.

FIG. 11 illustrates a flowchart of operations and interactions between the on-the-fly timing subsystem and the packaged algorithm subsystem during packaged algorithm adjustments in an embodiment of the system.

FIG. 12 illustrates a script view with a subtitle script on display in an embodiment of the system.

FIG. 13 illustrates a video view with a video playing in an embodiment of the system.

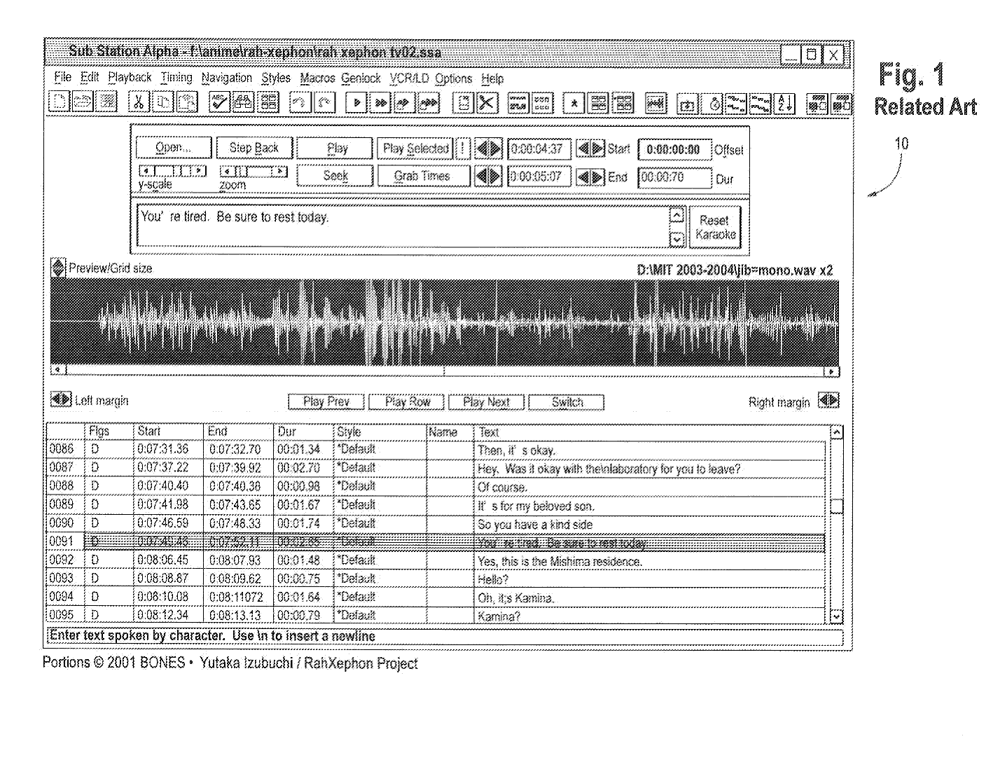

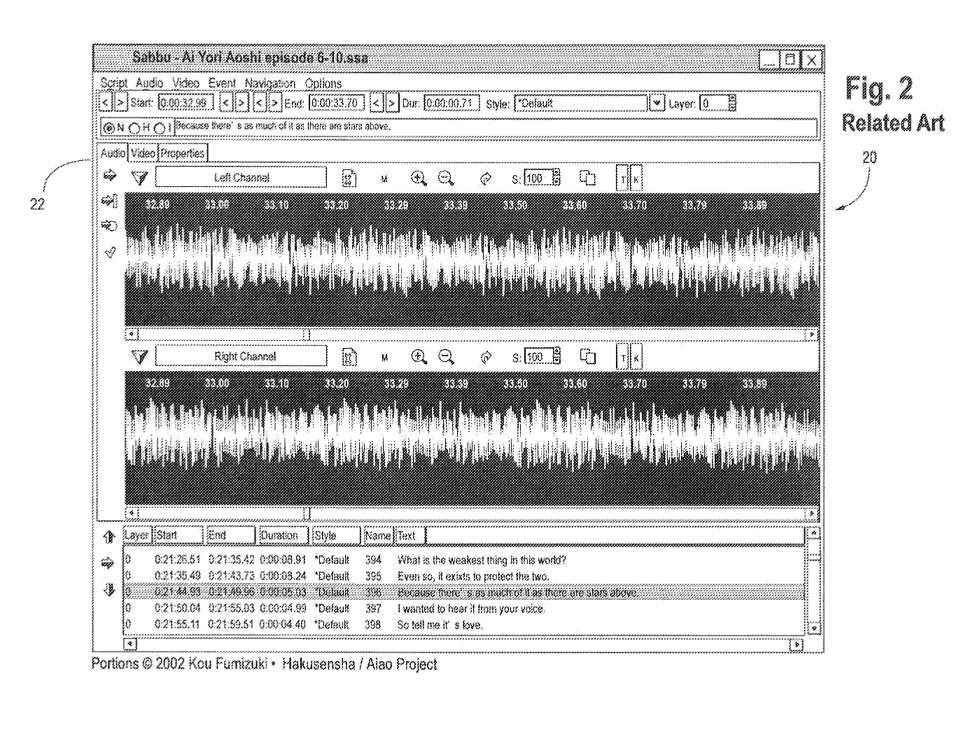

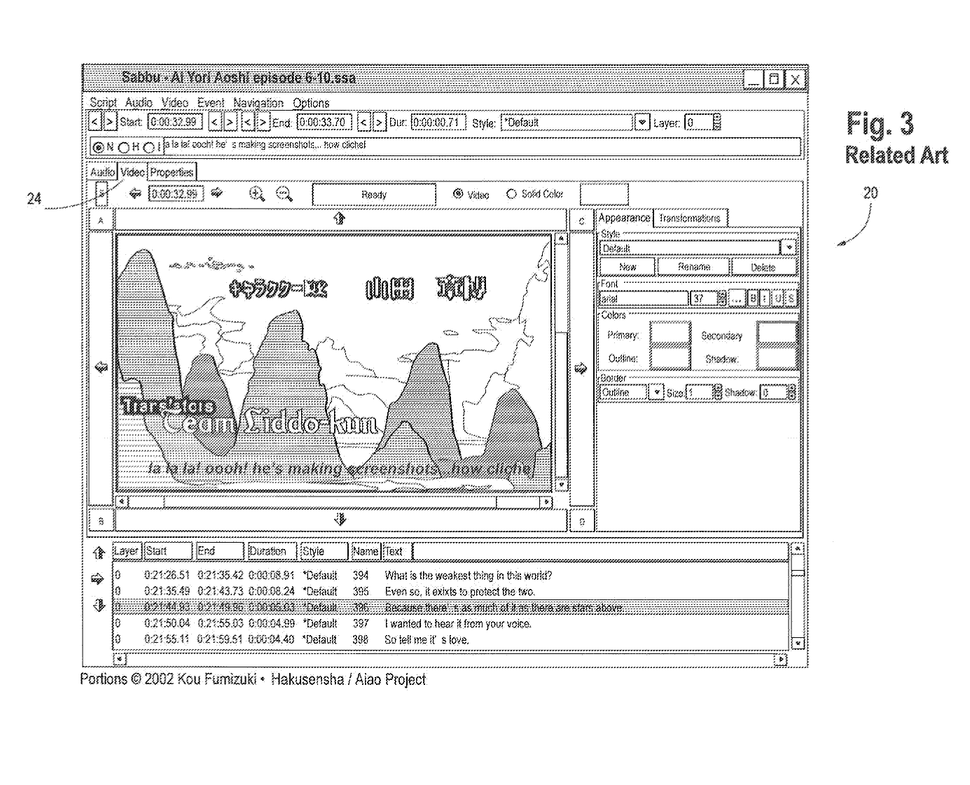

### DETAILED DESCRIPTION

Embodiments of a rapid subtitling system 100 are disclosed herein. Embodiments of the system 100 employ an on-the-fly timing subsystem, a packaged algorithm subsystem, and optionally include any combination of the following five feature groups: choice of platform, user interface of the script and video views, data storage and manipulations, internationalization via unicode, and localization via resource tagging. One of skill in the art will appreciate that a packaged algorithm is also known as an oracle or software module.

Without limitation, embodiments of the system 100 are well suited for professional, academic, fan, and novice use. Typically, different users emphasize the need for different capabilities. For instance, subtitling fans are typically concerned about typesetting and animation capabilities, while subtitling professionals consider typesetting capabilities such as data and time format support to be of secondary importance. Embodiments of the system 100 address some of the peculiarities of subtitling in the Japanese animation community, but also generalizes to the subtitling of media in other languages.

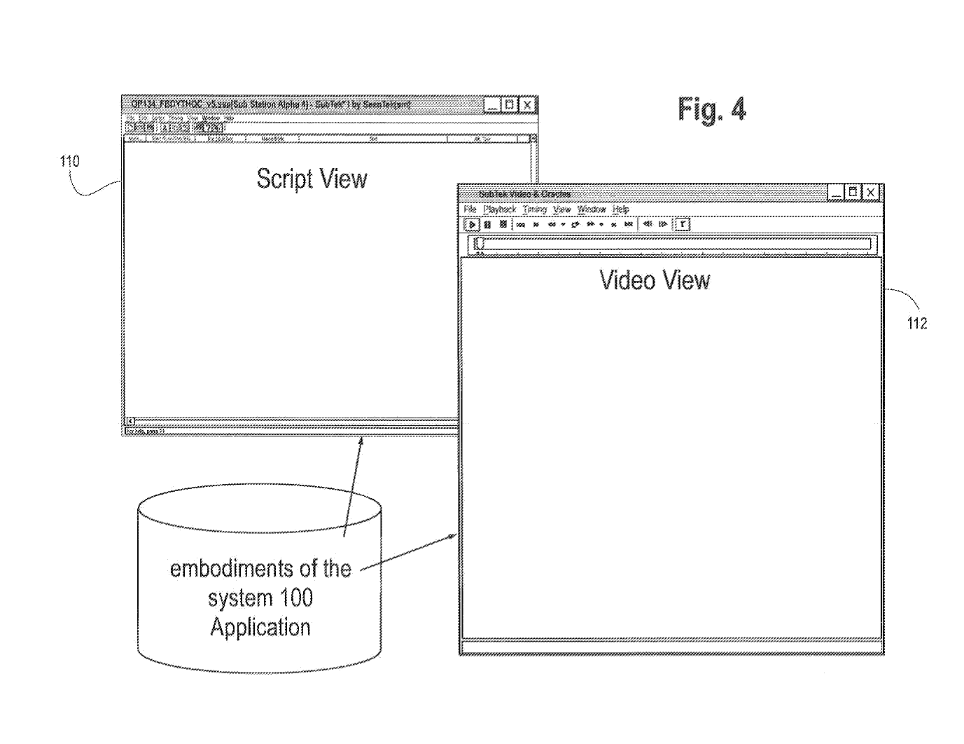

FIG. 4 illustrates a high level overview of an embodiment of the system 100 which includes a script view 110 and a video view 112. With reference to FIG. 5, one embodiment of the system 100 application object 102 is a singleton that forms the basis for execution and data control. The application creates and holds references to the scriptframe and its views (collectively hereinafter script view 110), and the video & packaged algorithms frame and view (collectively hereinafter video view 112). Unlike most previous subtitling applications, which may put video or media presentation in a supporting role to the script, both script view 110 and video view 112 are equally important in embodiments of the system 100. Both views are full windows with distinct user interfaces. The user can position these views anywhere and on any monitor with which the user feels comfortable.

The embodiment of the system 100 disclosed in FIG. 5 also includes application preferences 115, utility libraries 120, VMRAP9 125, a preview filter module 130, a filter graph module 135, and a format conversion/serialization module 140. This embodiment of the system 100 is disclosed to work with and modify a document 145.

When embodiments of the system 100 are launched, one embodiment of the application object 102 loads, performs initialization of objects, and reads saved preferences from the system 100 and the system preference store. Then, the application object 102 loads script view 110 and video view 112. From script view 110, users interact directly with the events (subtitles) and data in the script, including loading scripts from and saving scripts to disk via serialization objects. A distinct scriptobject holds the script's data, including events. All modules communicate with the scriptobject.

Embodiments of the system 100 encapsulate subtitles, commands, comments, notifications, and various types of audiovisual sequences in event objects. Textual items such as commands may be literal commands for a human user (e.g., “turn on the genlock”) or computer-executable code. Textual items such as subtitles can appear anywhere on-screen (thus including supertitles), and can be in any language, including sign language or Braille. In addition to this event data, an event object has timing and identification data associated with it. The latter data indicates the start and end times of the event, metadata such as comments about the event, style and group associations with the event, the type of data stored in the event (subtitle, comment, etc.), and so forth.

Embodiments of the system 100 treat data that timing information is to be applied against as sequences. In embodiments of the system 100, the most common set of sequences includes audio and video, as would be found in a video clip. As with event objects, however, a set of sequences can include other data streams. A textual data stream that contains computer-executable code, for example, might appear as part of a video file. Audiovisual files containing non-editable subtitles may encode these subtitles as a type of textual sequence, rather than as event objects that a user would normally manipulate.

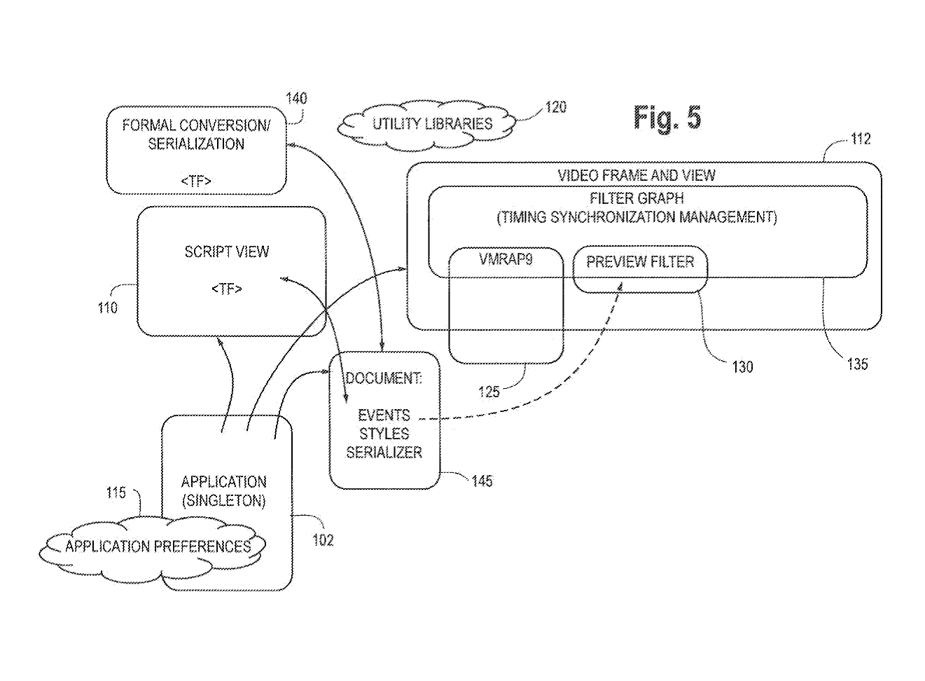

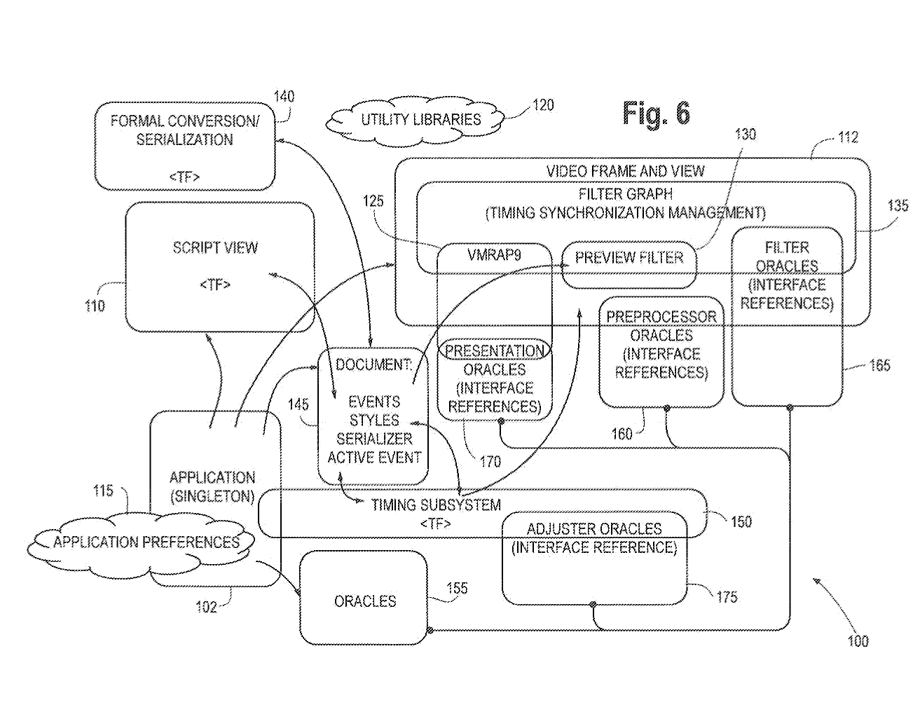

In video view 112, users load and play media clips using a video playback mechanism. In embodiments of the system 100, this playback functionality is managed by a filter graph and customized filters. One implementation of a filter graph and filters may be found in Microsoft DirectShow. More generally, filters are sources, transforms, or renderers. Data is pushed through a series of connected filters from sources through transforms to renderers; the renderers in turn deliver media data to hardware, i.e., to audio and video cards, and ultimately to the user. Embodiments of the system 100 provide a preview filter mechanism that renders formatted subtitles atop the video stream. A highly customized video renderer appears at the end of the video chain. This renderer is illustrated in FIG. 5 and FIG. 6 as the VMRAP9 125, an underlying technology employed in embodiments of the system 100 that use 3D acceleration on the graphics card to prepare and present video. In another embodiment, however, 3D acceleration is not used, provided that an appropriate interface exists to present sequence data to the user.

In embodiments of the system 100, the filter graph is also responsible for regulating and synchronizing the flow of data. This regulation may be accomplished using reference clock hardware that certain filters make accessible. If the filter with the reference clock is the audio renderer and the reference clock is used, for example, playback of audio, video, and other sequences may be presented to the user as one would expect for regular media playback. This configuration is typical for embodiments of the system 100 users who watch and time a media clip during playback.

In other embodiments, sequence processing is not synchronous or even at the same rate. Sequences run asynchronously and independently, including backwards or with different playback offsets per stream. In some embodiments, this processing occurs without the aid of a hardware reference clock. This configuration is useful, for example, if a user is not a human user and an embodiment is to run as fast as the processor and other hardware can compute. In another case, a human user may prefer to hear the audio stream in advance of seeing the video stream and the packaged algorithm visualizations described below. The user may more accurately indicate start and end times for events when the corresponding video and visualizations appear on-screen.

FIG. 5 shows the aforementioned objects as well as application preferences, utility libraries, and transform filters in embodiments of the system 100. Rounded rectangles are objects; overlapping objects indicate owner-owned relationships. Single-headed arrows indicate awareness and manipulation of the pointed-to object by the pointing object. Awareness may be achieved by a reference or pointer to an instantiated object in memory. Manipulation may be achieved by programmatic calls from the pointing object's code to functions that comprise the pointed-to object or that require the pointed-to object as a parameter. The Application, for example, creates and destroys the script and video view 112 objects in response to system 100 events.

The single-headed dotted-line arrow indicates an observer-subject relationship: the preview filter receives updates when events in the scriptobject change. Double-headed arrows indicate mutual dependencies between two objects or systems. Modules throughout the system 100 use application preferences and utility libraries, so specific connections are not shown; rather, these objects are indicated as clouds. In this context, transform filters are first-class function objects, or closures, that transform scriptobject elements and filter them into element subsets. Transform filters appear as <tf> in FIG. 5 and FIG. 6. A thorough discussion of transform filters follows below.

FIG. 6 completes embodiments of the system 100 object model with an on-the-fly timing subsystem 150 and packaged algorithm subsystem 155, as described in the following section. Circle-headed connectors indicate how single objects (namely, packaged algorithms) expose their multiple interfaces to different client objects.

In embodiments of the system 100, the on-the-fly-timing subsystem 150 and packaged algorithm subsystem 155 control and automate the selection of event start and end times. As discussed above, even the most sophisticated video and audio processing algorithms alone do not typically reach the levels of accuracy required in the subtitling process. In particular, speech boundary detection algorithms tend to generate far too many false positives due to breaks in speech or changes to tempo for dramatic effect. Even if an automated process can track audiovisual cues with 100% accuracy, a human user may still be desirable to confirm that generated times are optimal by watching the audiovisual sequence before audiences do. Audiences expect subtitles not to merely track spoken dialogue, but to express the artistic vision of the film or episode. Just as a literal translation would do violence to the narrative, so too may mechanical tracking destroy the suspense, release, and enlightenment of the visual dialogue, depending on the content. This constraint differs from live captioning of television broadcasts such as news and sports, where temporary desynchronization is generally considered acceptable. The objective of live captioning is receipt of raw information, rather than simultaneous communication of that information with the audiovisual sequence to preserve a particular dramatic effect.

Embodiments of the system 100 treat user-supplied times as a priori data and adjust these inputs based on packaged algorithms that extract features from concurrent data streams or from the user's preferences. User-supplied times may be provided by any process external to the two subsystems. A user need not be human, nor does the user need to be present for the complete timing operation. In another implementation, times may be batched up (that is, recorded from a user's input), saved to disk, and replayed or provided in one large, single adjust request. A more complete discussion of alternative embodiments such as the aforementioned follows below.

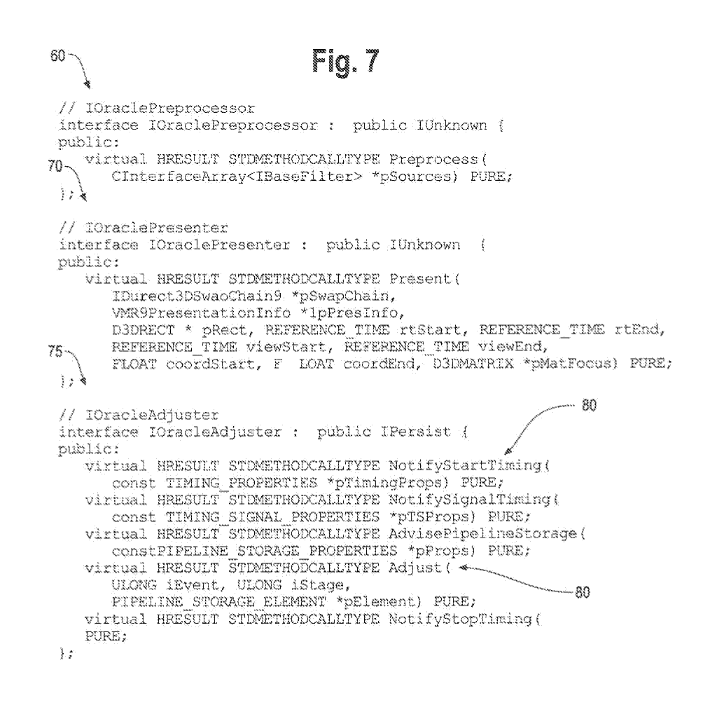

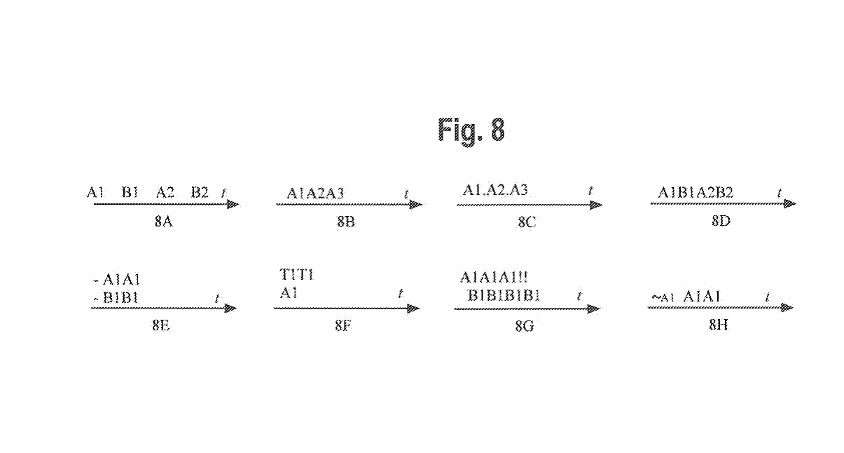

As disclosed in FIG. 6. algorithms in the packaged algorithms 155 are packaged in objects, which expose one or more interfaces: a preprocessor algorithm 160, a filter algorithm 165, a presenter algorithm 170, and an adjuster algorithm 175, according to the Interface Segregation Principle. Now referring to FIG. 7, it lists C++ prototypes from embodiments of the system 100 for the preprocessor algorithm 160, the presenter algorithm 170, and the adjuster algorithm 175. Embodiments of the system 100 uses Microsoft® DirectShow's IBaseFilter interface as a proxy for the filter packaged algorithm interface.

The application object 102 distributes ordered lists of these interface references to appropriate subsystems. These subsystems invoke appropriate commands on the interfaces, in the order provided by the application object.

Consider one such packaged algorithm as an example, the video keyframe packaged algorithm, further described below. Invoking the preprocess method on the preprocessor interface causes a packaged algorithm to preprocess the newly-loaded file or remove the newly-unloaded file. The video keyframe packaged algorithm preprocesses the stream by opening the file, scanning through the entire file, and adding key frames to a map sorted by frame start time. As a performance optimization, the video keyframe packaged algorithm's preprocess launches a worker thread that scans the file using a private filter graph while the video view continues to load and play in the main filter graph.

The filter interface is similar to the preprocessor interface in that one of its objectives may be to analyze stream data. However, another possible scenario is to transform data passing through the video view 112's filter graph in response to events on one of the other interfaces. One constraint of a media filter is that it cannot manipulate the filter graph directly, so computer resources may dictate, for example, when large buffers can be pre-filled with data substantially ahead of the current media time. Attempting to pre-fill such large buffers may exhaust computer resources when all of the filters in the graph generate and store large quantities of data without deleting such data.

The presenter interface is invoked before the video is presented to the user. In embodiments of the system 100, the presenter interface is invoked before a 3D rendering back buffer is copied to screen. While embodiments of the system 100 provides a predefined area of the screen to update, the packaged algorithm may draw to any point in 3D space. The video keyframe packaged algorithm uses presentation time information to render the key frames as lines on a scrolling display. Packaged algorithms are multithreaded objects, so great care is taken to synchronize access to shared variables while preventing deadlocks.

The on-the-fly timing subsystem uses the adjuster interface to notify packaged algorithms of user-generated events and to adjust times in the packaged algorithm pipeline, described below. Since embodiments of the system 100's timing subsystem first compiles user-generated events into a structure for the packaged algorithm pipeline, a review of several possible subtitle transition scenarios will help to build a case for the timing system's behavior.

Since events during on-the-fly timing pass in real time, the user has very little chance to react by issuing many distinct signals, i.e., by pressing many distinct keys, when a subtitle is to begin or end. There are at least eight basic transitions between subtitles; an objective of the present embodiment is to map signals to scenarios while reducing or eliminating as many scenarios as possible. Each scenario listed below in (A) through (H) may be understood using a mini-timeline, respectively shown in 8A through 8H. In these figures, speakers of subtitles are characters named A and B, while the specific subtitle for that character is listed by number appended to the character's designated letter. More formally, data designated as originating from a character has some concurrent relation to the other data streams, such as the audiovisual sequence. Thus, character utterances include, but are not limited to, sound effects (“Pop!” “clanging cymbals”), character thoughts seen or understood from the audio or video, and narration by an invisible narrator.

In 8F, the letter T designates a stream (comprised of supertitles, for instance) that is related to the audiovisual sequence, but that may be inserted as translator's notes. The translator may be seen as a character in a broad sense, even though the translator is not actually a character or actor in the audiovisual sequence. Empty space indicates no one is speaking at that time. The right arrow indicates that time t is increasing towards the right.
(A) Characters speaking individually and distinctly. This scenario requires one signal pair: start (transition to signal) and end (transition to non-signal), corresponding to the start and end times of an event.
(B) A character speaking individually but not distinctly. Characters may speak a prolonged monologue that cannot be displayed naturally as one subtitle. A user may be able to concurrently signal start and end, but this procedure may be confusing. The user may find it more convenient to issue an adjacent signal, which effectively means to stop one subtitle and start a second subtitle at the same time. Therefore, there shall be three signals: start, adjacent, and end.
(C) A character speaking individually but not very distinctly. This scenario is similar to scenario (B), except that it may or may not be possible to issue two separate sets of signals given human reaction time. Speakers temporarily stopping at a natural pause would fit this scenario. If this scenario is treated as scenario (B), the adjustment phase, rather than the user signaling phase, should distinguish between these times.
(D) Characters speaking indistinctly. In a heated dialogue between two or more speakers, it may not be possible to signal distinct start and end times. However, we know who is speaking (character A or B) from the translated or transcripted dialogue, which lists the speaker. This a priori knowledge may serve as a strong hint to the adjustment phase; for the user signaling phase, this knowledge means that the signals need not be distinct. Therefore, this scenario reduces to scenario (B).
(E) Characters speaking in a dialogue on the same subtitle (typically delimited by hyphens at the beginning of lines). While it is unlikely that multiple characters will speak the exact same utterances at the exact same times, the combination of events in the subtitle data reduces this scenario to scenario (A), with one signal pair. It is more likely, however, that a human operator will err by issuing false positives at the actual transition in speech: A stops talking and B starts talking, but the human operator fails to see that A and B talking are in the same event. Therefore, a go back signal may be desired.
(F) Non-character with subtitle. A translator's note or informational point may appear on-screen while a character is talking. Typically, however, these collisions occur only temporally. Spatially, the translator's note may be rendered elsewhere on-screen, for example, as a supertitle. In this case, the user may generate either no signal or an ignore signal. Another approach, however, is to filter out non-character events so that they are not presented during timing.
(G) Collisions: characters interrupt one another. If this scenario occurs, it occurs very briefly but causes great disruption: A typically stops talking within milliseconds of B starting. While sophisticated processing during the adjustment phase may identify this scenario, preserving the collision is undesirable for technical and artistic reasons. Many DVD players may crash or otherwise fail when presented with subpicture collisions. Treating scenario (G) as an adjacency, scenario (D), would be technically incorrect from the standpoint of recognition, but practically correct from the standpoint of external technical constraints. On the artistic side, some subtitling professionals report that audiences find collisions jarring, perhaps more so than the interruption on-screen. If the subtitles spatially collide, the viewer's reading is interrupted in addition to watching the interruption in the audiovisual sequence. A translator or transcriptionist would thus tend to reduce this scenario to scenario (E).
(H) Characters utter unsubtitled grunts or other false-positives before speaking. In this case, a false-positive will lead to a false-positive signal from a user, such as from a human operator. However, the error is that the signal is issued too early, rather than too late. This scenario may be addressed by a restart signal.

From studying these eight scenarios, three core signals emerge: start, adjacent, and end. Further, three optional signals emerge: back, restart, and next.

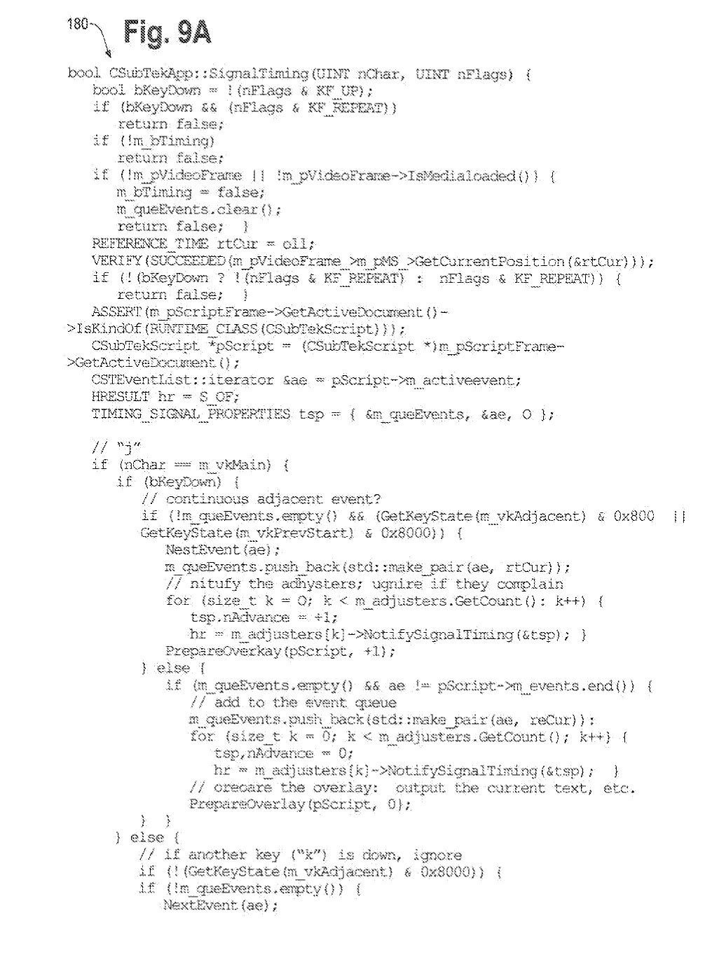

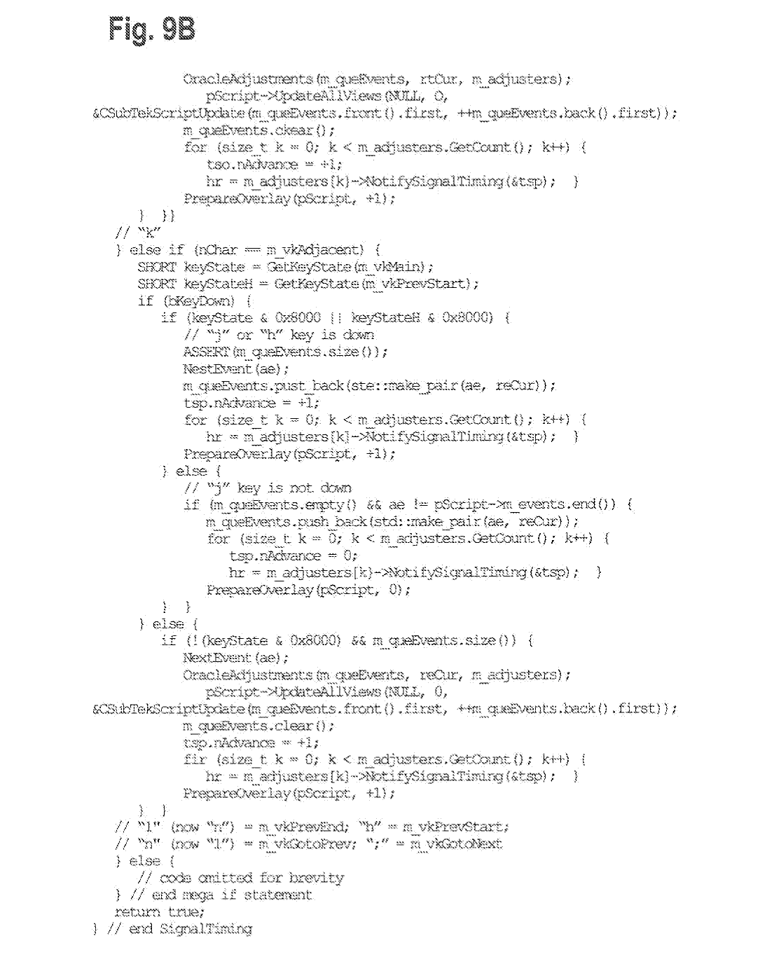

While timing mode is active, user-generated events are forwarded to a signaltiming function. FIG. 9A and FIG. 9B comprise a C++ implementation from embodiments of the system 100 of the signaltiming function 180's core start, end, and adjacent signal handling. Signaltiming builds a temporary queue, called an event queue, of adjacent events, then submits the queue for adjustment in the packaged algorithm pipeline. In more concrete terms, the scriptobject stores a reference to the active event, a subtitle or other audiovisual event. When the user depresses the “J” or “K” keys, the timing subsystem stores the time and event. The actual keys are customizable, but the keys described in herein are the defaults in embodiments of the system 100. These keys correspond to the most natural position in which the right-hand may rest while on a QWERTY keyboard. When the key is released, the time is recorded as the end time, and the queue is sent to the packaged algorithm adjustment phase, as described below.

If “J” or “K” is depressed while the other is depressed, signaltiming will interpret this signal as an adjacent. The time is recorded as the adjacent time corresponding to the end of the active event and the start of the next event, which is designated the new active event. Release of one of these keys will be ignored, but release of the final key results in an end signal as above.

The aforementioned embodiment supposes that all events to be timed exist, and that all events to be timed are made available to the signaltiming function in some order so that “J” and “K” functions can choose the appropriate next event. The event list that signaltiming uses can be customized using event filters is shown in FIG. 6 and suggested below.

A further embodiment generates events during the timing process. If the user reaches a position of the event list such as the end, for example, pressing “J” or “K” triggers the creation of a new event object. The new event is then added to the scriptobject, such as at the end of the event list. In another embodiment, the user may have the audiovisual playback pause while the user enters event data, after the user triggers event creation or releases a key or all keys. For the user to enter event data, a popup window appears with prompts for event data, or the focus shifts to the relevant event in script view 110. When the user finishes entering new event data, playback and the timing process resume.

In yet another embodiment, the timing process merely collects time information using the steps outlined above, but does not create events or require exact matching of entered times to existing events. In such an embodiment, event creation is deferred for later, for example, after a batch of times is recorded.

In embodiments of the system 100, every signal that results in a change to the event queue also causes signaltiming to notify the adjuster packaged algorithms by calling their notifysignaltiming functions. The packaged algorithm may respond in real time to changes in the event queue before the packaged algorithms actually adjust the time. For instance, the packaged algorithm may display, through the presenter interface, a list or selected properties of the events in the queue or of events succeeding or preceding events in the queue. A further embodiment invokes the Interface Segregation Principle to separate notifysignaltiming onto a separate packaged algorithm interface, such as a signaltimingsink interface, from the adjuster interface.

Two navigational keys specify “designate the previous event active, and cancel any stored queue without running adjustments” (defaults to “L”) and “designate the next event active, canceling the queue” (defaults to “;”). Advanced and well-coordinated users may use “H” to “repeat,” or set the previous event active and signal “begin.” They may also use “N” to re-signal “begin” on the current active event. Given the difficulty of memorizing one keystroke, however, it is expected that users will use “J” and “K” for almost all of their interactions with the program.

When “end” is signaled, the event queue is considered ready for packaged algorithm adjustment. Embodiments of the system 100 prepares a two-dimensional array of pipeline storage elements; the array size corresponds to the number of stages—equal to the number of adjuster interfaces—by the number of events plus one. This plus one on the event extent is for processing the end time. However, in an alternate embodiment, a two-dimensional array is not prepared, and the adjustment phases are run with dynamically-created individual pipeline storage elements. In such an alternate embodiment, the adjusting packaged algorithms have limited or no access to past or future values of candidate times as other adjusting packaged algorithms process those times.

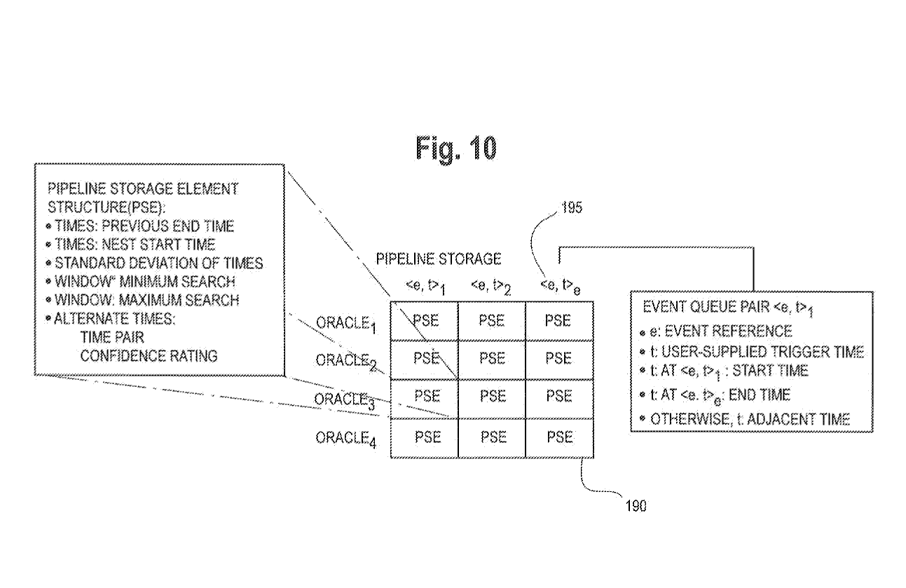

In embodiments of the system 100, as shown in FIG. 10, each pipeline storage element 190 stores primary times and additional data regarding confidence levels and alternate times. This additional data includes:
(A) standard deviations for primary times,
(B) alternate times,
(C) confidence ratings on the alternate times, and
(D) a window specifying the absolute minimum and maximum times in which to search.

While each pipeline segment corresponds to one event and one time (start, adjacent, or end)—event-time-pair 195 as shown in FIG. 10—packaged algorithms may separate an adjacent time into unequal last end and next start times. The packaged algorithm for each stage examines the pipeline storage with respect to the current event and stage. The packaged algorithm is provided with the best known times from the previous stage, but the packaged algorithm also has read access to all events in the pipeline. All previous stages before the packaged algorithm in question are filled with cached times. Storage of and access to this past data is useful, for example, when computing optimal subtitle duration: the absolute time for the current stage depends on the optimal times from previous stages. In an alternate embodiment, packaged algorithms have read and write access to all events in the pipeline through the packaged algorithms' adjuster interfaces.

Pipeline storage further exposes to the packaged algorithm subsystem the interfaces of the packaged algorithms corresponding to each stage. Each adjuster interface further exposes a unique identifier of the concrete class or object, so an adjuster can determine what actually executed before it or what will execute after it.

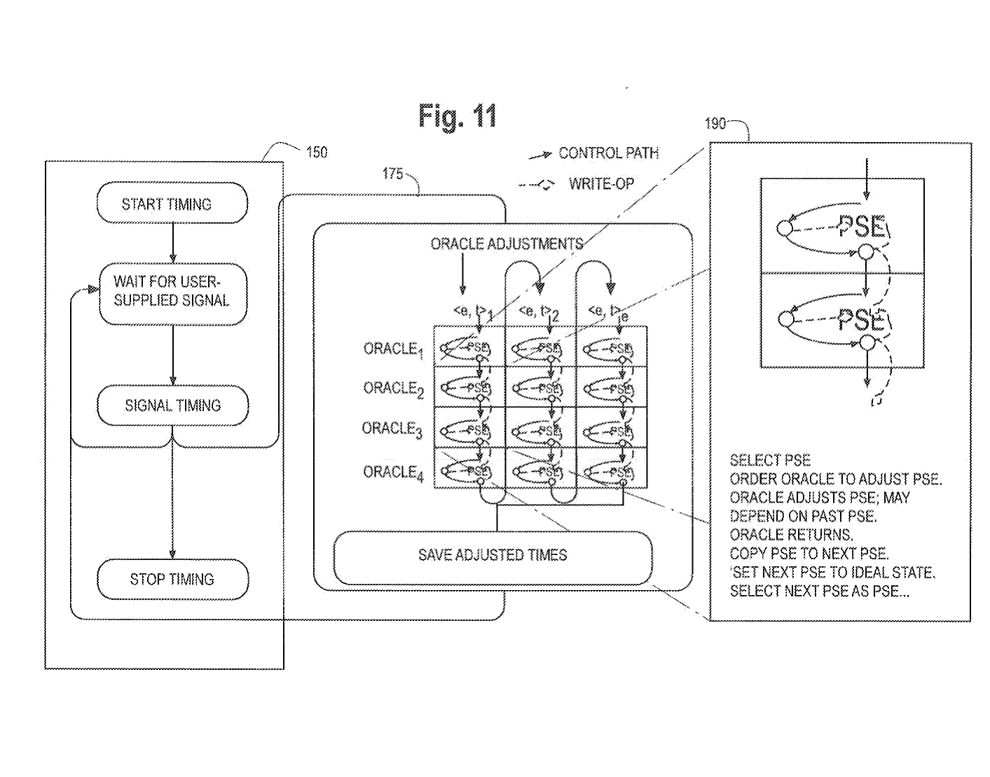

As shown in the FIG. 11 flowchart, control weaves between the on-the-fly timing subsystem 150 and the adjuster code 175 in the packaged algorithm subsystem. The Adjust method of the adjuster interface receives a non-constant reference to its pipeline storage element, into which it writes results. When control passes back to the on-the-fly timing subsystem, the subsystem may, at its option, adjust or replace the results from the previous adjuster. At the end of a pipeline segment for an event, the timing subsystem replaces the times of the event with the final-adjusted times.

In principle, these exposures violate the Dependency Inversion Principle of object-oriented programming, which states that details should depend upon abstractions. However, it is best to think of the packaged algorithm adjustment phase as a practically-controlled, rather than formally-controlled, network of dependencies. The primary control path through the pipeline constitutes normal execution, but a highly-customized mix of packaged algorithms may demand custom code and unforeseen dependencies. In this case, a single programmer or organization might create or assemble all of the packaged algorithms; such a creator would understand all of the packaged algorithms' state dependencies. An advanced user, in contrast, could specify which packaged algorithms operate in a particular order in the pipeline for specific behavior, but those effects would be less predictable if one packaged algorithm depends on the internal details of another. Finally, if an audio processing algorithm is known to provide spurious results on particular data, a subsequent packaged algorithm could test for that particular data from that particular packaged algorithm and ignore the previous stage's results. Replacing one algorithm with another is as simple as replacing a single packaged algorithm interface reference, thus placing emphasis on the whole framework for delivery of optimal times.

Human interaction plays an important role in this framework, but there are alternative modes of operation in further embodiments. The framework may be operated without real time playback by supplying prerecorded user data or by generating data from another process. There is no explicit requirement that times strictly increase, for example: the controlling system 100 may generate times in reverse. The filter and presenter interfaces do not have to be supplied to the VMRAP9 125 and filter graph modules, thus saving processor cycles.

Furthermore, the user need not be a human operator at all. Instead, the user may be any process that delivers times as signals or as direct times to be processed by the packaged algorithm and on-the-fly timing subsystems. Such a process may take and evaluate data presented concurrently in the form of video and audio streams (with relevant overlays from packaged algorithm presenter interfaces), or it may ignore such data.

Nevertheless, embodiments of the system 100 do not implement these alternatives in light of the aforementioned constraints of the problem domain. First, irrespective of the Interface Segregation Principle, a packaged algorithm may use its presenter or filter behavior to influence the packaged algorithm's behavior on the other interfaces, namely the adjuster interface. Causal audio packaged algorithms, for example, might implement audio processing and feature extraction on their filter interfaces, while a video packaged algorithm might read bits from the presentation surface to influence how it will adjust future times passed to it. For instance, the user may present spatial data in the form of mouse clicks and drags on the presentation surface, gesturing that some start and end times should change. As set forth below, the sub dur packaged algorithm presents a visual estimate of the duration of the hot subtitle, which may subtly influence a user's response. Presenter and filter interfaces should be seen as part of a larger feedback loop that involves, informs, and stimulates the user.

Second, packaged algorithms may save computation time by relying on user feedback from the adjuster interface to influence data gathering or processing on the other interfaces. A signage movement detector in another embodiment, for example, would perform (or batch on a low-priority thread) extensive computations on a scene, but only on those scenes where the user has indicated that a sign is currently being watched. In a further implementation, a packaged algorithm would have write access to events themselves during time-gathering phase, or would be given pipeline storage elements that recorded other changes to events for manipulation in the packaged algorithm adjustment phase.

Third, in many applications it is faster for a user to react in real time to a subtitle, and for a computation to perform an exhaustive search in a limited range, than it is for a computation to search a much more expansive range and require the user to pick from many suboptimal results. In an embodiment reversing the operations proposed above, the timing subsystem could generate signals in small, equally-spaced intervals and see where those input times cluster after being adjusted by stateless packaged algorithms. However, the computer may not be good at picking from wide ranges of data; humans are not good at quickly identifying precise thresholds. If the user takes care of the macro-identification, the system 100 should take care of the rest.

For certain alignment operations, however, this reversed embodiment should prove more successful. For instance, the user may desire to find the time when a single known, unordered subtitle event (with text) is uttered in an audiovisual sequence that the user has not seen before. Using this reversed embodiment will yield specific times that the user can then examine, which should be faster than the user watching the entire sequence. Upon choosing the proper time, the user should then micro-adjust (or perform a further operation using the aforementioned embodiments) to align the subtitle with the proper start and end times.

In one embodiment of the system 100, the following packaged algorithms were employed. The list parenthetically notes the interfaces that the packaged algorithms exposed. The enumerated order presented below corresponds to the order of these packaged algorithms in the packaged algorithm pipeline of the embodiment:

(1) Sub queue packaged algorithm (presenter, adjuster): Displays the active event and any number of events before (prev events) and after (next events) the active event. In embodiments of the system 100, this packaged algorithm presents text over the video using Direct3D. Therefore, it is extremely fast. This packaged algorithm does not perform adjustments in the pipeline. Thus, as described above it relies on the notifysignaltiming function but not the Adjust function.

(2) Audio packaged algorithm (preprocessor, presenter, adjuster): Preprocesses audio waveforms by constructing a private filter graph based on the video view 112 filter graph and continuously reading data from the graph through a sink (a special renderer) that delivers data to a massive circular buffer. The packaged algorithm presents the waveform as a 3D object rendered to the presentation area of the video view, with the vertical extent zoomed to see peaks more easily. The packaged algorithm computes the time-based energy of the combined-channel signal using Parseval's relation and a windowing function. The packaged algorithm adjusts the event time by picking the sharpest transition towards more energy (in), towards less energy followed by more energy (adjacent), or towards less energy (end) in the window of interest specified by the pipeline storage element.

(3) Optimal sub dur packaged algorithm (presenter, adjuster): Receives notification when a new event becomes active, and renders a horizontal gradient highlight in the packaged algorithm area indicating the optimal time and last-optimal time based on the length of the subtitle string. In embodiments of the system 100, this packaged algorithm uses the formula

0.2 sec+0.06 sec×number of characters in the subtitle event

to determine the optimal display time. On adjust, this packaged algorithm only adjusts the time if the current time is off by more than twice a precomputed standard deviation (a function of the number of characters) from the optimal time. In that case, the packaged algorithm discards the inherited pipeline value and sets the time in the pipeline to at least the minimum (0.2 sec) or at most the maximum time within the precomputed standard deviation. Alternate embodiments specify alternate visual or aural notifications, alternate formulae, and alternate thresholds for adjusting the time.

(4) Video keyframe packaged algorithm (preprocessor, presenter, adjuster): Preprocesses the loaded video by scanning for key frames. Key frames are stored in a map data structure (typically specified as a sorted associative container and implemented as a binary tree), sorted by time, and are rendered as yellow lines in the packaged algorithm presentation area. On adjust, if proposed times are within a user-defined threshold distance of a key frame, the times will snap to either side of the key frame.

A further embodiment includes an Adjacent Splitter packaged algorithm. Such a packaged algorithm splits the previous end and next start times, forming a minimum separation to prevent visual smearing, or direct blitting: the minimum separation and direction of separation may be supplied by a user or outside process as a static or time-dependent preference. One such reasonable value is two video frames, the time value of which depends on the video's frame rate. In this further embodiment, the adjacent splitter packaged algorithm could appear at the end of the pipeline (4.1).

A further embodiment includes a Reaction Compensation packaged algorithm. Such a packaged algorithm compensates for the reaction time of a user. A typical untrained human user may react to audiovisual boundaries around 0.1 seconds after they are displayed and heard. For this case, this packaged algorithm would subtract 0.1 seconds from every proposed input time. With training, however, a user may be dead on always, may only input skewed values for starts and ends—not adjacents—or may input times too early. This packaged algorithm compensate for all such types of errors. In this further embodiment, the Reaction Compensation packaged algorithm could appear at the beginning of the pipeline (0.1). One rationale for this positioning is so that subsequent packaged algorithms search through the temporal area that best corresponds with the user's intent.

Should an implementer desire to implement different algorithms, the implementer would create another packaged algorithm supporting the aforementioned interfaces and insert that packaged algorithm into the optimal position in the pipeline.

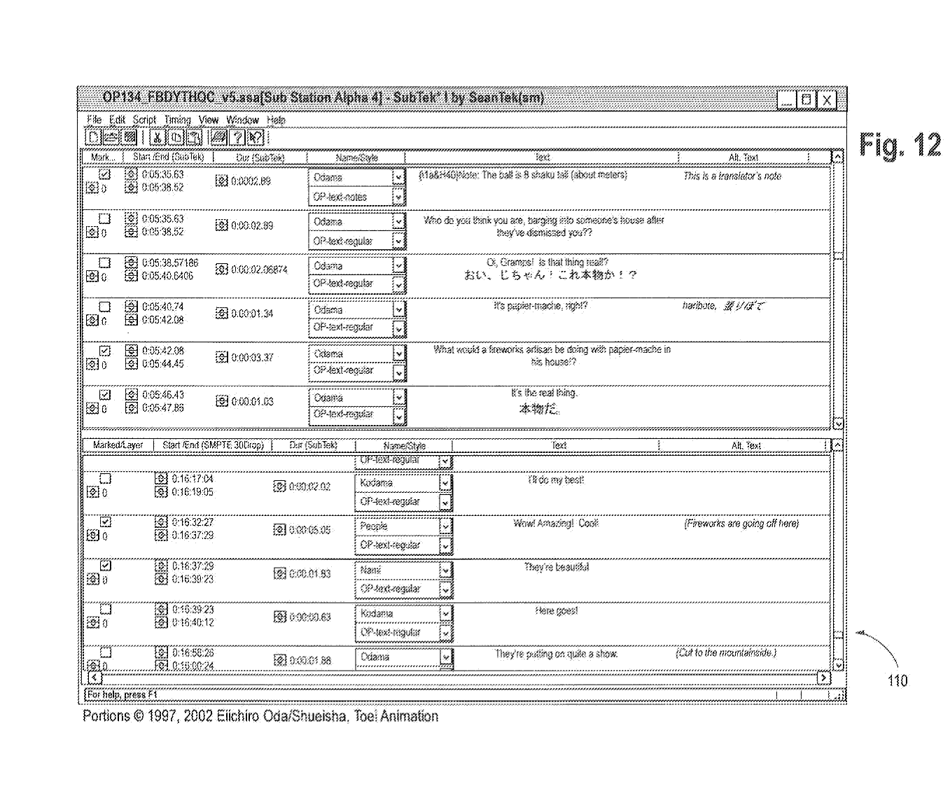

Embodiments of the disclosed system 100 optionally run on any platform. However, such embodiments tend to employ several different audiovisual technologies that have traditionally resisted easy porting between platforms. A typical human user interface includes an audio waveform view and a live video preview with dynamic subtitle overlay. Although only one video view 112 and script view 110 are displayed in embodiments of the system 100, alternate embodiments permit additional video views for multiple frames side-by-side, multiple video loops side-by-side, zoom, pan, color manipulation, or detection of mouse clicks on specific pixels. As evident in FIG. 12, multiple script view 110s are supported in the frame via splitter windows. An alternative embodiment may display those views in distinct script frames.

Many subtitlers use Windows machines because existing subtitling software is Windows-based, and because Windows has a mature multimedia API through DirectShow. Therefore, embodiments of the system 100 are implemented on Microsoft Windows using the Microsoft Foundation Classes, Direct3D, DirectShow, and i18n-aware APIs such as those listed in National Language Support. While reference to embodiments of the system 100 design may at times use Windows-centric terminology, one of skill in the art will appreciate that alternate embodiments are not limited to technologies found on Windows.

While embodiments of the system 100 and methods described herein are applicable to any platform, targeting a specific platform per embodiment has distinct advantages. Each platform and abstraction layer maintains its distinct object metaphors, but an abstraction layer on top of multiple platforms may implement the lowest common denominator of these objects. Embodiments of the system 100 takes advantage of some Windows user interface controls, for example, for which there may be no exact match on another platform. Alternatively, some user interface controls are identical in appearance and user functionality, but may require equivalent but not identical function calls.

Since performance and accuracy are also at a premium in embodiments of the system 100, coding to one platform allows for the greatest precision with the least performance hit on that platform. For example, the base unit for time measurement in embodiments of the system 100 is REFERENCE_TIME (TIME_FORMAT_MEDIA_TIME) from Microsoft DirectShow, which measures time as a 64-bit integer in 100 ns units. This time is consistent for all DirectShow objects and calls, so no precision is lost when getting, setting, or calculating media times. Conversions between other units, such as SMPTE drop-frame time code and 44.1 kHz audio samples, can use REFERENCE_TIME as a consistent intermediary. Furthermore, embodiments of the system 100 attempts to present a consistent user experience as other applications designed for Windows, which should lead to a shallower learning curve for users of that platform and greater internal reliability on interface abstractions.

As illustrated in FIG. 6, the scriptobject in embodiments of the system 100 is at the center of interactions between many other components, many of which are multithreaded or otherwise change state frequently.

Event objects, described above, are stored in C++ Standard Template Library lists rather than arrays or specialized data structures. This storage has led to several optimizations and conveniences that permit execution of certain operations in constant time while preserving the validity of iterators (that is, encapsulated pointers) to unerased list members. In embodiments of the system 100, most objects and routines that require event objects also have access to an event object iterator sufficiently close to the desired object on the list, so that discovering other event objects occurs in far less than linear time.

Rather than relying on the Microsoft Foundation Classes'CView abstraction, which requires a window to operate, embodiments of the system 100 implements its own Observer design pattern to ensure data consistency throughout all embodiments of the system 100 controls and user interface elements. The Observer is an abstract class with some hidden state, declared inside of the class being observed. Objects that wish to observe changes to an event object, for example, inherit from Event::Observer. When either the observer or the subject are deleted, special destructors ensure that links between the observer and the observed are verified, broken, and cleaned up safely.

Professional translators and subtitlers maintained a fairly extensive list of features they would have liked to see, but their most oft-requested feature was support for SMPTE drop-frame time code, an hh:mm:ss:ff format for time display for video running at 29.97 Hz. Embodiments of the system 100 employs several serialization and deserialization classes to specifically handle time formats, converting between REFERENCE_TIME units, SMPTE objects that store the relevant data in separate numeric fields, TimeCode objects that store data in a frame count and an enumeration for the frame rate, and strings.

Embodiments of the system 100 supports event transforms, event filters, and event transform filters, mentioned briefly before and shown in FIG. 5 and FIG. 6. Filters are function objects, or simulated closures, that are initialized with some state. Filters are used to select subsets of event objects, while event transforms manipulate, ramp, or otherwise modify event objects in response to requests from the user. For example, a time offset and ramp could be encapsulated in an event transform; embodiments of the system 100 would then apply this transform to a subset of events, or to the entire event list in the scriptobject. Filter and transform objects and functionality as described above have existed in computer science literature, but they did not appear in the reviewed subtitling software implementations that incorporate filtering. Moreover, these reviewed implementations do not seem to implement transformations and filters as reusable objects throughout the subtitling application.

Some additional applications of these transform filters in embodiments of the system 100 are noted in the following sections.

In FIG. 12, embodiments of the system 100's script view 110 uses highly-customized rows of subclassed windows common controls and custom-designed controls. By default, the height of each row is three textual lines. In this present embodiment, code behind the controls themselves handles most but not all functionality. Customized painting and clipping routines prevent unnecessary screen updates or background erasures. Although the script view 110 code has to manage the calculation of total height for scrolling purposes, one ramification of this configuration is that the view can process a change to an event object in amortized constant time rather than in linear time in the number of events in the script.

The script view 110 maintains records of its rows in lists as well. Each row in the list stores an iterator to the event being monitored. The iterator stores the event's position on the scriptobject's event list, in addition to its ability to access the event by reference. If the user selects a different filter for the view, embodiments of the system 100 will apply the filter when iterating forwards or backwards until the next suitable iterator is found for the next matching event.

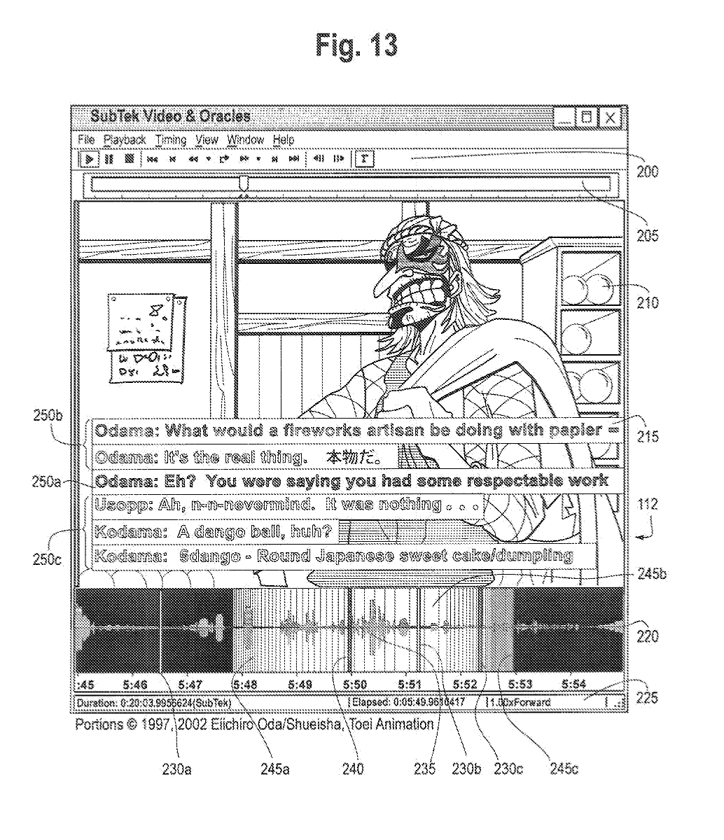

As shown in FIG. 13, the video view 112 is divided into several regions: the toolbar 200, seek bar 205, video display 210, packaged algorithm display 215, a waveform bar 220 and a status bar 225. Since the VMRAP9 125 manages the inner view (as mentioned previously), packaged algorithm and video drawing fall under the same routine. The sub queue packaged algorithm takes advantage of this feature, for example, by drawing the active queue items on-screen at presentation time. FIG. 13 illustrates the video view 112 with all packaged algorithms active, tying the user into a large feedback loop that culminates with the packaged algorithm adjustment phase of the on-the-fly timing subsystem.

Embodiments of the system 100 are both internationalized—the application can work on computers around the world and process data originating from other computers around the world—and localized—the user interface and data formats that it presents are consistent with the local language and culture.

Windows applications running on Windows 2000, XP or Vista can use Unicode® to store text strings. The Unicode standard assigns a unique value to every possible character in the world; it also provides encoding and transformation formats to convert between various Unicode character representations. Characters in the Basic Multilingual Plane have 16-bit code point values, from 0x0000 to 0xFFFF, and may be stored as a single unsigned short. However, higher planes code point values through 0x10FFFF, require the use of a surrogate pair. Where necessary, embodiments of the system 100 also supports these surrogate code points and the UTF-32 format, which stores Unicode values as single 32-bit integers. Internationalization features are evident, for example, in the mixed text of the script view 110 (FIG. 12) and the video view 112 (FIG. 13).

Although some scripts are stored in binary format (the version of embodiments of the system 100 described herein supports limited reading of Microsoft Excel files, if Excel is installed), most scripts are stored as text with special control codes. Consequently, the encoding of the text file may vary considerably depending on the originating computer and country. Embodiments of the system 100 rely on the Win32 API calls MultiByteToWideChar and WideCharToMultiByte to transform between Unicode and other encodings. Embodiments of the system 100 query to enumerate all supported character encodings, and presents them in customized Open and Save As dialogs for script files. Since these functions rely on operating system support, they add considerable functionality to the system 100 without the complexity of a bundled library file.

Windows executables store much of their non-executable data in resources, which are compiled and linked into the .exe file. Resources are also tagged with a locale ID identifying the language and culture to which the data corresponds; multiple resources with the same resource ID may exist in the same executable, provided that their locale IDs differ. Calls to non-locale-aware resource functions choose resources by using the caller's thread locale ID. Embodiments of the system 100 set its thread locale ID on application initialization, and the thread locale ID is set to a user-specified value. Employing this approach, resources still have to be compiled directly into the executable. Users cannot directly provide custom strings in a text file, for example. On the other hand, advanced implementers with access to the source code may compile localized resources as desired. An alternate embodiment provides resources such as text strings and images in one or more separate resource files, which the user can select in order to change the language or presentation of the user interface.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled. While the foregoing description of embodiments of the system 100 may contain many specificities, these specifics should not be construed as limitations on the scope of the system 100 set forth above, but rather as an exemplification of several embodiments thereof. Many other variations are possible. For example, the functionality of the packaged algorithm subsystem and on-the-fly timing subsystem can be merged or separated into different subsystems at various stages and run at different times, such that the user need not be an interactive human user, and events can be made of data other than subtitles, such as audio snippets, pictures, or annotations.

What is claimed is:

1. A computer implemented method of updating parameters relating at least one event to at least one data sequence, the method comprising:
receiving parameter values from a user;
storing the parameters in a memory communicatively connected to the computer in a manner so that the stored parameters relates at least one event to at least one data sequence;
extracting at least one feature from the data sequence; and
adjusting parameters based on the at least one feature extracted from the data sequence.

2. The method of claim 1, wherein receiving the parameter values from a user further comprises presenting a representation of the data sequence.

3. The method of claim 2, wherein receiving the parameter values from a user further comprises presenting a representation of the event.

4. The method of claim 2, wherein extracting at least one feature further comprises filtering the data sequence to present information to the user.

5. The method of claim 2, wherein receiving the parameter values includes receiving a batch of parameters saved on a computer readable medium.

6. The method of claim 3, further comprising executing a textual data stream containing computer executable code as part of at least one of a video view and a script view.

7. The method of claim 6, further comprising adjusting the presentation of the video view in response to adjusted parameters in real-time.

8. The method of claim 3, wherein receiving the parameters further comprises receiving parameters in the form of at least one of (1) a mouse click on some part of the representation of the data sequence; (2) a mouse drag on some part of the of the representation of the data sequence; (3) a key depress; and (4) key release.

9. The method of claim 4, wherein extracting at least one feature further comprises at least one of (1) extracting features from a concurrent stream of the data sequence; and (2) extracting features from a previously analyzed stream of the data sequence.

10. The method of claim 4, wherein filtering the data sequence further comprises computing time based energy in the data sequence using the Parseval's relation and a windowing function.

11. The method of claim 3, wherein the event includes at least one of (1) a textual item; (2) an audio event; and (3) a visual event.

12. The method of claim 2, wherein the data sequence includes at least one of: (1) an audio sequence; (2) a video sequence; and (3) a textual sequence.

13. The method of claim 3, wherein at least one of the parameters is a media time corresponding to the sequence.

14. The method of claim 12, further comprising presenting the data sequence to the user in at least one of (1) original forward playback sequence; (2) reverse playback sequence; and (3) synchronously with one another.

15. The method of claim 12, further comprising presenting a first data sequence asynchronously with a second data sequence, wherein the first data sequence and the second data sequence are presented (1) at different rates and (2) at different offsets from another data sequence.

16. The method of claim 4, wherein filtering the data sequence further comprises at least one of (1) detecting scene boundaries from the data sequence; (2) detecting speech boundaries; (3) optimally separating the parameters of the event to a predetermined minimal cardinal separation; (4) delaying the parameters based on delayed or advanced reaction of the user; and (5) advancing the parameters based on delayed or advanced reaction of the user.

17. The method of claim 15, wherein detecting scene boundaries further comprises detecting video key frames.

18. The method of claim 3, further comprising communicating indicia representing the events and data sequences to the user based on one or more of the parameters via an indicating means operatively connected to the memory.

19. The method of claim 17, further comprising receiving additional parameter values from the user in response to the indicia.

20. The method of claim 17, further comprising presenting at least one of (1) the events; (2) the data sequences; (3) intermediate results generated by the method; (4) and modifications to the parameters; to the user by means of at least one hardware apparatus.

21. The method of claim 17, further comprising receiving the parameters from the user by means of an electromechanical apparatus.

22. The method of claim 6, wherein extracting at least one feature further comprises filtering the data sequence to synchronize the flow of the data sequence.

23. A system for updating parameters relating at least one event to at least one data sequence, the system comprising:
an input module adapted to receive parameter values from a user;
a computer readable memory communicatively connected to the computer and adapted to store the parameters in a manner so that the stored parameters relate at least one event to at least one data sequence; and
an analysis module adapted to extract at least one feature from the data sequence and to adjust the parameters based on the at least one feature extracted from the data sequence.

24. The system of claim 23, wherein the input module further comprises a presentation module adapted to (1) present a representation of the data sequence using a video view; (2) present a representation of the data sequence using a script view; and (3) present a menu via the script view to receive an input from the user.

25. The system of claim 23, wherein receiving the parameter values from a user further comprises presenting a representation of the data sequence.

26. The system of claim 25, wherein receiving the parameter values from a user further comprises presenting a representation of the event.

27. The system of claim 25, wherein extracting at least one feature further comprises filtering the data sequence to present information to the user.

28. A computer readable medium storing computer readable instructions that, when executed, perform a method for updating parameters relating at least one event to at least one data sequence, the method comprising:
receiving parameter values from a user;
storing the parameters in a memory communicatively connected to the computer in a manner so that the stored parameters relate at least one event to at least one data sequence;
extracting at least one feature from the data sequence; and
adjusting parameters based on the at least one feature extracted from the data sequence.

29. The system of claim 28, wherein receiving the parameter values from a user further comprises presenting a representation of the data sequence.

30. The system of claim 29, wherein receiving the parameter values from a user further comprises presenting a representation of the event.

31. The system of claim 29, wherein extracting at least one feature further comprises filtering the data sequence to present information to the user.

32. A system for updating parameters relating at least one event to at least one data sequence, the system comprising:
an input module adapted to receive parameter values from a user and present a representation of the data sequence;
a computer readable memory communicatively connected to the computer and adapted to store the parameters in a manner so that the stored parameters relate at least one event to at least one data sequence; and
an analysis module adapted to extract at least one feature from the data sequence and to adjust the parameters based on the at least one feature extracted from the data sequence, wherein extracting the at least one feature further comprises filtering the data sequence to present information to the user.

33. The system of claim 32, wherein receiving the parameter values from a user further comprises presenting a representation of the event.
